(19) United States
(12) Patent Application Publication
(10) Pub. No.: US 2024/0220336 A1
(43) Pub. Date: Jul. 4, 2024

(54) Processing Element-Centric All-to-All Communication

(71) Applicant: Advanced Micro Devices, Inc., Santa Clara, CA (US)

(72) Inventors: Kishore Punniyamurthy, Austin, TX (US); Khaled Hamidouche, Austin, TX (US); Brandon K Potter, Troup, TX (US); Rohit Shahaji Zambre, Seattle, WA (US)

(73) Assignee: Advanced Micro Devices, Inc., Santa Clara, CA (US)

(21) Appl. No.: 18/147,081

(22) Filed: Dec. 28, 2022

(51) Int. Cl. G06F 9/54; G06F 9/50; G06F 15/173

(52) U.S. Cl. CPC G06F 9/54; G06F 9/5044; G06F 15/17356

(57) ABSTRACT

In accordance with described techniques for PE-centric all-to-all communication, a distributed computing system includes processing elements, such as graphics processing units, distributed in clusters. An all-to-all communication procedure is performed by the processing elements that are each configured to generate data packets in parallel for all-to-all data communication between the clusters. The all-to-all communication procedure includes a first stage of intra-cluster parallel data communication between respective processing elements of each of the clusters; a second stage of inter-cluster data exchange for all-to-all data communication between the clusters; and a third stage of intra-cluster data distribution to the respective processing elements of each of the clusters.

### BACKGROUND

Data processing by computing systems and devices utilize graphics processing unit (GPU) clusters as all-to-all collectives for high performance computing (HPC) algorithms, such as utilized for fast Fourier transform (FFT) applications. Additionally, some machine learning (ML) algorithms utilize all-to-all collectives as components of runtime. In conventional network topologies, some processing elements (PEs) are closer together than others, connected through higher bandwidth links creating a cluster domain. Conventional all-to-all algorithms for central processing unit (CPU)-based systems are limited by data packet creation overhead (e.g., for small data messages), and limited by network contention due to bandwidth constraints (e.g., for large data messages).

### BRIEF DESCRIPTION OF THE DRAWINGS

The detailed description is described with reference to the accompanying figures.

FIG. 1 depicts a non-limiting example of all-to-all communication in a distributed computing system, as related to processing element (PE)-centric all-to-all communication, as described herein.

FIG. 2 depicts a non-limiting example topology of another distributed computing system, such as related to aspects of PE-centric all-to-all communication, as described herein.

FIG. 3 depicts a block diagram of a non-limiting example system for PE-centric all-to-all communication, as described herein.

FIG. 4 depicts a non-limiting example of a distributed computing system in an initial state, as related to aspects of PE-centric all-to-all communication, as described herein.

FIG. 5 further depicts a non-limiting example of intra-cluster all-to-all communication in the distributed computing system, as related to aspects of PE-centric all-to-all communication, as described herein.

FIG. 6 further depicts a non-limiting example of inter-cluster exchange for all-to-all communication in the distributed computing system, as related to aspects of PE-centric all-to-all communication, as described herein.

FIG. 7 further depicts a non-limiting example of intra-cluster data exchange for all-to-all communication in the distributed computing system, as related to aspects of PE-centric all-to-all communication, as described herein.

FIG. 8 further depicts a non-limiting example of a final state of the distributed computing system, as related to aspects of PE-centric all-to-all communication, as described herein.

FIG. 9 depicts a non-limiting example of levels of clustering, as related to aspects of PE-centric all-to-all communication, as described herein.

FIG. 10 depicts a procedure in example implementations of PE-centric all-to-all communication, as described herein.

### DETAILED DESCRIPTION

In aspects of the techniques described herein for PE-centric all-to-all communication, a GPU-centric procedure exploits GPU parallelism to enhance all-to-all data communication in a distributed processing system. All-to-all communication in a multi-GPU system (or multi-processing elements system) means being able to distribute data across a set of clusters in a distributed system of GPUs, CPUs, hardware FPGAs, and/or any other type of processing elements. For example, a distributed computing system may have four clusters, and each cluster has processing elements (e.g., GPUs, CPUs, FPGAs, and/or any other type of processing element) to which the data is distributed utilizing an optimized communication pattern, such as an all-to-all collective that is initiated as a function call for algorithm, hardware, and/or software optimization. The GPU-centric procedure described herein utilizes GPU parallelism to overcome packet creation latency, thus alleviating the bottleneck when data message sizes are relatively small, and also reduces inter-cluster messages, thus reducing network contention, which is essential for communication of relatively larger data messages.

Typically, all-to-all communication is utilized in both high performance computing (HPC), such as for FFT applications, and utilized in machine learning (ML) applications, such as for a deep learning recommendation model (DLRM). In some network topologies, processing elements (PEs) are closer together than others, connected through higher bandwidth links (e.g., XGMI-based multiple GPUs within a single node, a dragonfly network, and CXL-domains) creating a cluster domain. As noted above, these HPC and ML applications are limited by data packet creation overhead (for small message size) or network contention due to bandwidth limitations (for large message size). However, with the advent of GPU-initiated network communication, network requests and messages can be issued by individual threads, wavefronts, and work groups. This GPU parallelism is utilized to improve all-to-all collective algorithms, and further implement aspects of the techniques described herein for PE-centric all-to-all communication.

Accordingly, the described aspects of PE-centric all-to-all communication exploits the configuration of cluster domains within a network and GPU parallelism (or generally, processing units parallelism) and achieves faster all-to-all communications. The configuration of cluster domains in a distributed computing system is beneficial for performance, but not required for functionality of the features of PE-centric all-to-all communication, as described herein for faster all-to-all communication. Notably, aspects of the described PE-centric all-to-all communication are utilized and leveraged by any type of CPU, APU, GPU, hardware FPGA, and/or other types of processing elements or computing units. Various aspects of the described PE-centric all-to-all communication provide techniques for an all-to-all communication procedure using GPU-triggered network operations, rather than existing algorithms that use host CPU-triggered network communications. The GPU-centric nature of the all-to-all communication procedure allows for utilizing the processing elements in parallel in clusters of a distributed computing system.

In aspects of the described techniques for PE-centric all-to-all communication, a distributed computing system includes processing elements, such as graphics processing units (GPUs), distributed in clusters. An all-to-all communication procedure is performed by the processing elements that each generate data packets in parallel for all-to-all data communication between the clusters. The all-to-all communication procedure includes a first stage of intra-cluster parallel data communication between respective processing elements of each of the clusters, and the data packets are coalesced from which a single data message is generated for inter-cluster communication between a pair of the clusters. The all-to-all communication procedure includes a second stage of the inter-cluster data exchange for all-to-all data communication between the clusters, and a third stage of intra-cluster data distribution to the respective processing elements of each of the clusters, completing the all-to-all data communication between the clusters.

In some aspects, the techniques described herein relate to a distributed computing system comprising multiple clusters that each include processing elements, and an all-to-all communication procedure performed by the processing elements that are each configured to generate data packets in parallel for all-to-all data communication between the multiple clusters.

In some aspects, the techniques described herein relate to a distributed computing system where the processing elements of the multiple clusters are graphics processing units (GPUs).

In some aspects, the techniques described herein relate to a distributed computing system where the processing elements are each configured to communicate the data packets in parallel intra-cluster.

In some aspects, the techniques described herein relate to a distributed computing system where the data packets include at least GET requests or PUT requests communicated by the processing elements in parallel intra-cluster.

In some aspects, the techniques described herein relate to a distributed computing system where a single data message is communicated between a pair of the multiple clusters for the all-to-all data communication between the multiple clusters.

In some aspects, the techniques described herein relate to a distributed computing system where the data packets are coalesced in a send buffer from which the single data message is generated for inter-cluster communication between the pair of the multiple clusters.

In some aspects, the techniques described herein relate to a distributed computing system where the single data message is communicated from the send buffer to a receive buffer for the inter-cluster communication between the pair of the multiple clusters.

In some aspects, the techniques described herein relate to a distributed computing system where the all-to-all communication procedure comprises a first stage of intra-cluster parallel data communication between respective processing elements of each of the multiple clusters, and data is coalesced for inter-cluster data exchange, a second stage of the inter-cluster data exchange for the all-to-all data communication between the multiple clusters, and a third stage of intra-cluster data distribution to the respective processing elements of each of the multiple clusters.

In some aspects, the techniques described herein relate to a distributed computing system where the all-to-all communication procedure is performed in a number of steps that is twice a number of clustering levels plus one additional step.

In some aspects, the techniques described herein relate to an all-to-all communication procedure executable by graphics processing units (GPUs) distributed in clusters, the all-to-all communication procedure comprising a first stage of intra-cluster parallel data communication between respective GPUs of each of the clusters, a second stage of inter-cluster data exchange for all-to-all data communication between the clusters, and a third stage of intra-cluster data distribution to the respective GPUs of each of the clusters.

In some aspects, the techniques described herein relate to an all-to-all communication procedure where the first stage includes data coalesced intra-cluster for the inter-cluster data exchange.

In some aspects, the techniques described herein relate to an all-to-all communication procedure where data is coalesced in a send buffer from which a single data message is generated for the inter-cluster data exchange between a pair of the clusters.

In some aspects, the techniques described herein relate to an all-to-all communication procedure where the second stage comprises a single data message being communicated between a pair of the clusters for the inter-cluster data exchange.

In some aspects, the techniques described herein relate to an all-to-all communication procedure where the single data message is communicated from a send buffer to a receive buffer for the inter-cluster data exchange between the pair of the clusters.

In some aspects, the techniques described herein relate to a method of performing an all-to-all communication procedure by GPUs distributed in clusters, generating data packets in parallel for all-to-all data communication between the clusters, and communicating a single data message between a pair of the clusters for the all-to-all data communication.

In some aspects, the techniques described herein relate to a method including coalescing the data packets in a send buffer from which the single data message is generated for inter-cluster communication between the pair of the clusters.

In some aspects, the techniques described herein relate to a method including communicating the single data message from the send buffer to a receive buffer for the inter-cluster communication between the pair of the clusters.

In some aspects, the techniques described herein relate to a method where the all-to-all communication procedure comprises a first stage of intra-cluster parallel data communication between respective GPUs of each of the clusters.

In some aspects, the techniques described herein relate to a method where the all-to-all communication procedure comprises a second stage of an inter-cluster data exchange for the all-to-all data communication between the clusters.

In some aspects, the techniques described herein relate to a method where the all-to-all communication procedure comprises a third stage of intra-cluster data distribution to the respective GPUs of each of the clusters.

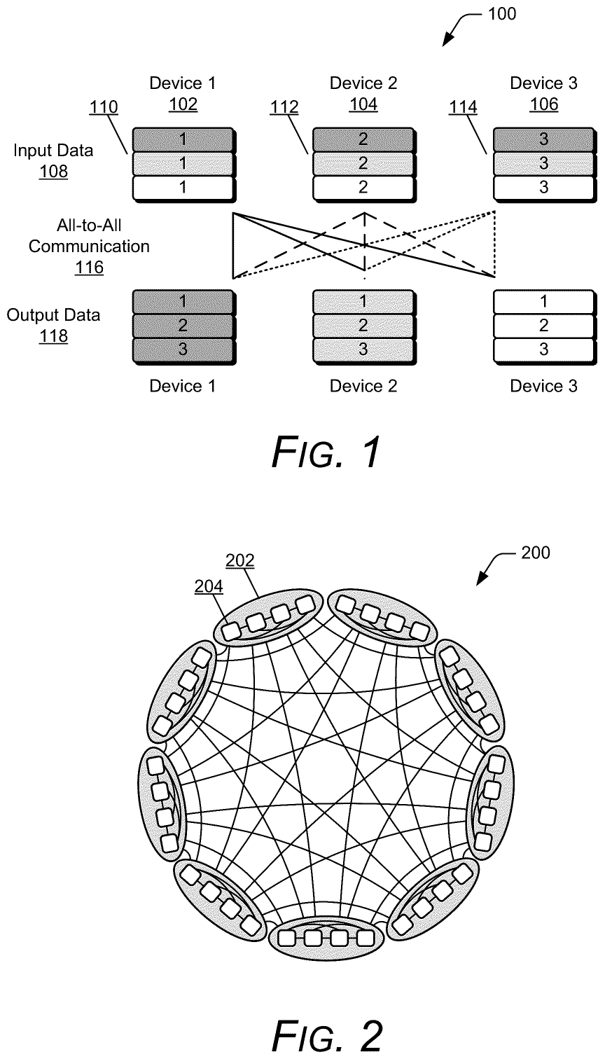

FIG. 1 depicts a non-limiting example of all-to-all communication in a distributed computing system 100, as related to PE-centric all-to-all communication, as described herein. This example is illustrative of any type of a distributed computing system or computing device that includes multiple system nodes or devices 102, 104, 106 configured for all-to-all communication between the three devices. Further, this example represents an all-to-all operation, and how the operation processes is based on underlying procedure, library calls, hardware configurations, etc. In this simple example, input data 108 is broken into three data sizes equal to the number of nodes (e.g., devices) participating in the cluster, and the input data 108 is then shuffled based on each device index. For an all-to-all operation, each of the devices 102, 104, 106 has respective input data, which is obtained or generated from a prior computation, and which is then shuffled between the devices using the all-to-all operation. For example, the first device 102 will have its input data (e.g., first input data 110), the second device 104 will have its input data (e.g., second input data 112), and the third device 106 will have its input data (e.g., third input data 114).

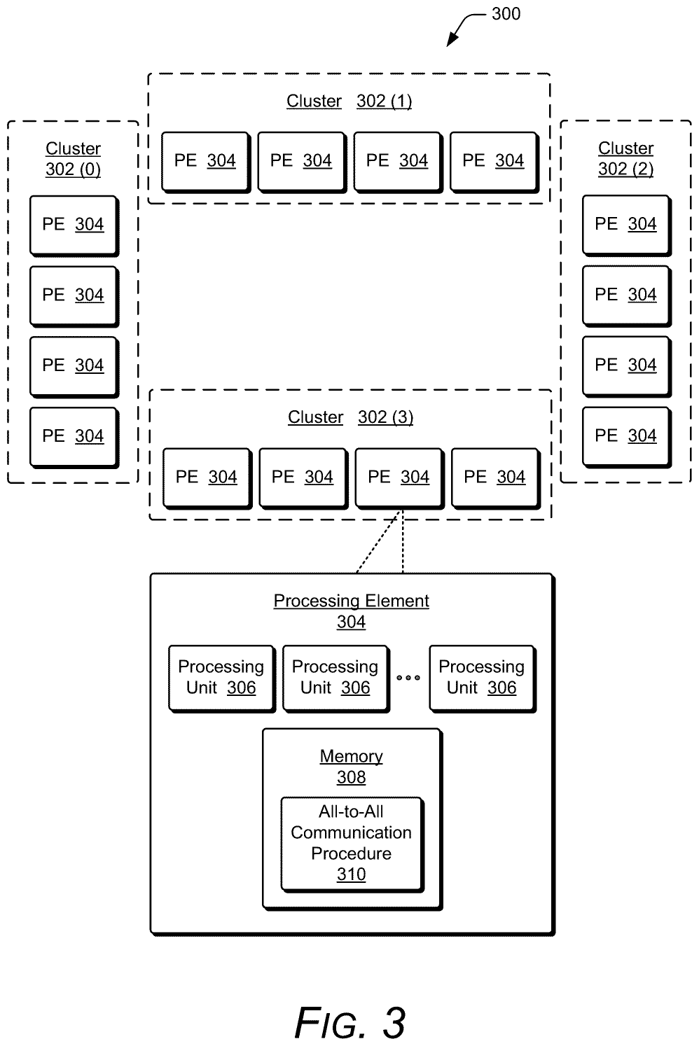

An implementation of all-to-all communication 116 results in each of the nodes (e.g., the three devices) in the distributed computing system 100 having output data 118 corresponding to the first, second, and third input data that is associated with each respective device. For example, the first device 102 has output data corresponding to the first input data 110, the second input data 112 from the second device, and the third input data 114 from the third device. The output data is similarly organized or allocated in the second device 104 and in the third device 106 based on the all-to-all communication 116. Although this example is shown and described with reference to only three system nodes or clusters, a distributed computing system can include any number of system nodes, devices, or clusters configured for all-to-all communication, such as further shown and described with reference to FIG. 2.

A factor in the selection of an all-to-all communication algorithm or procedure is the size of the data (e.g., 8 bytes, 8 MB, 1 Gb, etc.) to be communicated. With reference to relatively smaller message sizes, the time to create a data packet adds latency to the processing, generally because creating small data packets does not utilize the peak network bandwidth (e.g., is not limited by the network bandwidth). A typical algorithm can require log 2 N-steps for a number N nodes in a distributed computing system, whereas the all-to-all communication procedure described herein makes use of GPU parallelism to perform all-to-all communication in constant steps (e.g., assuming there is enough parallelism available in the processing elements (GPUs) of the distributed computing system).

For relatively larger message sizes (e.g., 1 Gb), network contention due to network bandwidth capabilities is the main bottleneck when message sizes are large. Conventional algorithms and topology specific strategies still rely on host CPU-initiated networking to schedule all-to-all communication and avoid network contention. In aspects of PE-centric all-to-all communication as described herein, the processing elements in a distributed computing system are grouped within clusters, which optimizes inter-cluster communication. The described techniques result in a single (e.g., only one) data message needing to be communicated between a pair of clusters (e.g., per level, per direction), which reduces the network contention and the need for optimal inter-cluster communication scheduling overhead. Every conventional hierarchical topology has system nodes that are closer to each other and are suitable candidates for node clustering, which provides for implementations of PE-centric all-to-all communication as described herein.

FIG. 2 depicts a non-limiting example topology of another distributed computing system 200, such as related to aspects of PE-centric all-to-all communication, as described herein. In this example topology, the distributed computing system 200 includes multiple node clusters 202, each having four nodes 204 (e.g., computing devices, machines, processing elements, etc.). From a topology standpoint, the four nodes 204 in each of the multiple node clusters 202 are physically located closer together than to nodes in another node cluster, and hence are more tightly connected. Accordingly, data communications between the four nodes 204 in a particular node cluster are faster than data communications between the node clusters, due to limited bandwidth over fewer connections.

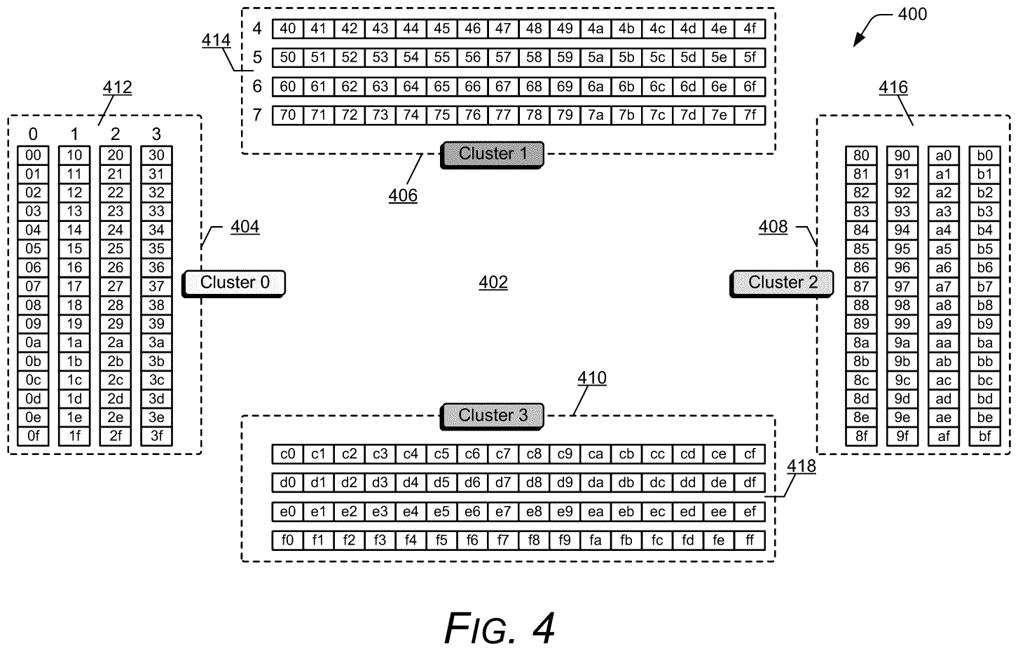

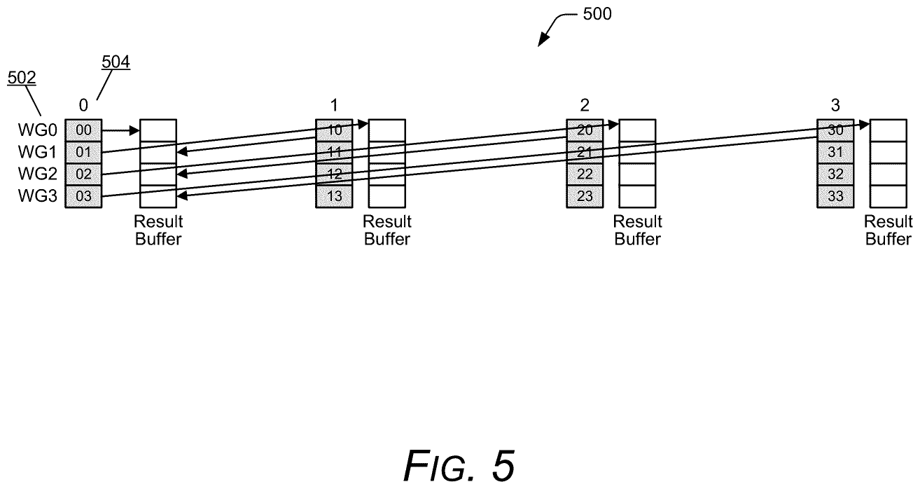

FIG. 3 is a block diagram of a non-limiting example system 300 for PE-centric all-to-all communication, as described herein. The example system 300 is illustrative of any type of a distributed computing system that includes multiple clusters 302 (e.g., clusters (0-3)) each with processing elements 304. In this example system 300, each of the multiple clusters 302 broadly represents a group of nodes (e.g., processing elements, or GPUs in this example). In implementations, the processing elements 304 of the multiple clusters 302 are graphics processing units (GPUs). In this example system 300, a processing element 304 includes any type of one or more processing units 306 and a memory 308 from which to access and execute an all-to-all communication procedure 310, as described herein. Notably, any of the processing elements 304 can include multiple processing units 306 within each processing element. In aspects of PE-centric all-to-all communication, the all-to-all communication procedure 310 is performed by the processing elements 304 that each generate data packets in parallel for all-to-all data communication between the multiple clusters 302. Details of the processing stages of the all-to-all communication procedure implemented in a distributed computing system are further shown and described with reference to FIGS. 4-8.

In implementations, the all-to-all communication procedure includes a first stage (or first step) of intra-cluster parallel data communication between respective processing elements 304 of each of the clusters 302, and the data packets are coalesced from which a single data message is generated for inter-cluster communication between a pair of the clusters. The processing elements 304 of a cluster 302 communicate the data packets in parallel intra-cluster. Each processing element 304 can include multiple processing units 306, and each of the processing units 306 communicates data packets in parallel, as well as parallelism within each processing element 304. In an implementation, the data packets include at least GET requests or PUT requests communicated by the processing elements 304 in parallel intra-cluster. Further, the data packets are coalesced in a send buffer from which the single data message is generated for inter-cluster communication between a pair of the clusters.

The all-to-all communication procedure 310 includes a second stage (or second step), which is the inter-cluster data exchange for all-to-all data communication between the clusters 302. In this stage, the single data message is communicated between a pair of the clusters 302 for the all-to-all data communication. In an implementation, the single data message is communicated from a send buffer of a cluster to a receive buffer of another cluster for the inter-cluster communication between the pair of clusters. The all-to-all communication procedure 310 includes a third stage of intra-cluster data distribution to the respective processing elements 304 of each of the clusters 302, completing the all-to-all data communication between the clusters.

Accordingly, the described aspects of PE-centric all-to-all communication provides several features, such as utilizing GPU parallelism and GPU-initiated communication to overcome packet creation latency, thus alleviating the bottleneck when messages sizes are small. The time taken to create relatively smaller data messages adds to the latency, which is typical with conventional all-to-all algorithms that use a host CPU-triggered communication. The described all-to-all communication procedure also reduces the number of inter-cluster messages, thus reducing network contention which is essential when the data messages are relatively larger. Notably, the inter-cluster messaging can be implemented synchronous or asynchronous, where the asynchronous processing extends the cluster processing and spreads the data communication over time, which does not congest network bandwidth used to communicate the data inter-cluster.

Additionally, the PE-centric all-to-all communication procedure is performed in only a number of steps (or stages) that is twice a number of the clustering levels plus one additional step. For a single level clustering, as shown in this example system 300, the all-to-all communication procedure is performed in only three steps or stages, which reduces the processing overhead encountered with conventional all-to-all algorithms. Each of the processing elements 304 (e.g., GPUs) sends multiple GET and PUT requests in parallel, effectively exposing the latency of only one call. In implementation examples, work groups are illustrated as issuing the requests, but can be substituted with work-items or wavefronts if more parallelism is needed. Further, unlike conventional all-to-all algorithms, the described PE-centric all-to-all communication procedure results in exactly one message being sent between every pair of clusters 302 (per direction), thus saving energy and latency on otherwise costly inter-cluster communication. All of the inter-cluster communication occurs in parallel if there is at least one path between any pair of clusters and the number (N) of PEs per cluster is greater than or equal to (>=) the number of clusters (C) in a specific level (i.e., both of these are reasonable assumptions and can be met). If the number (N) of PEs per cluster is less than (<) the number of clusters (C), then inter-cluster communications are serialized, or multiple levels of clusters are created, as further described below. Further, the multiple clusters 302 do not have to include only the processing elements 304 that are physically closer to each other.

FIG. 4 depicts a non-limiting example 400 of a distributed computing system 402 in an initial state, as related to aspects of PE-centric all-to-all communication, as described herein. In this example, the distributed computing system 402 includes four computing devices, indicated as clusters 404-410 connected by a network (not shown), and each computing device has four processing elements (0-3) (e.g., GPUs) for a total of sixteen processing elements in the distributed computing system. In this example, each computing device is itself a cluster 404-410 of the distributed computing system 402. It should be noted that a system cluster does not have to contain processing elements that are physically closer to each other. Further, as noted above, implementations of PE-centric all-to-all communication does not require separate distributed, individual clusters or nodes having multiple processing elements. Rather, aspects of PE-centric all-to-all communication could be implemented with only one cluster of sixteen processing elements, or any other combination of clusters and number of processing elements.

In this example, each computing device is itself a cluster 404-410 of the distributed computing system 402. Given this configuration, communicating between the processing elements of a cluster in the distributed computing system 402 is faster than communicating between the processing elements across the different clusters. For example, data communication between the four processing elements 412 (e.g., processing elements (0-3)) in the first cluster 404 is faster than data communication between the processing elements 412 in the first cluster and the processing elements 414 in the second cluster 406, the processing elements 416 in the third cluster 408, and the processing elements 418 in the fourth cluster 410. The data communication links connecting the individual processing elements are not shown in this example for simplicity.

In terms of implementation of the described PE-centric all-to-all communication, the distributed computing system 402 in this example 400 includes a number of clusters (denoted as C), each with a number (denoted as N) processing elements {PE₀, PE₁, PEᵢ, . . . PE_{N-1}}. The total number of processing elements (PEs) in the system is given by the number (N) processing elements multiplied by the number of clusters (C). In this example distributed computing system 402, the total number of sixteen processing elements is determinable from the four processing elements multiplied by the four clusters, and the initial state of the processing elements with sixteen data elements {00, 01, . . . 0f}, {10, 11, . . . 1f}, etc. is shown for each processing element. Further, the data on which the all-to-all communication is to be performed per processing element is broken into N*C pieces (i.e., the number (N) of processing elements multiplied by the number of clusters (C)), where each data piece could be one or more data elements. Each processing element (PE_{i,c}) within an individual cluster (c<C) is responsible for communicating with the next logical cluster in a circular order, and wraps around at the end. The cluster communicated by a processing element (PE_{i,c}) is c′_{I}=(c+i+1)% C (with different mappings possible for various implementations). For example, the processing element PE₀ in cluster(0) will communicate with cluster(1), the processing element PE₁ in cluster(0) will communicate with cluster(2), and so on. In implementations, extra data buffers are utilized, determined as two multiplied by (C−1) buffers of size NC elements (e.g., SBuf and Rbuf). Further, each processing element has NC number of concurrent work groups {WG₀, WG₁, . . . WG_{NC-1}}.

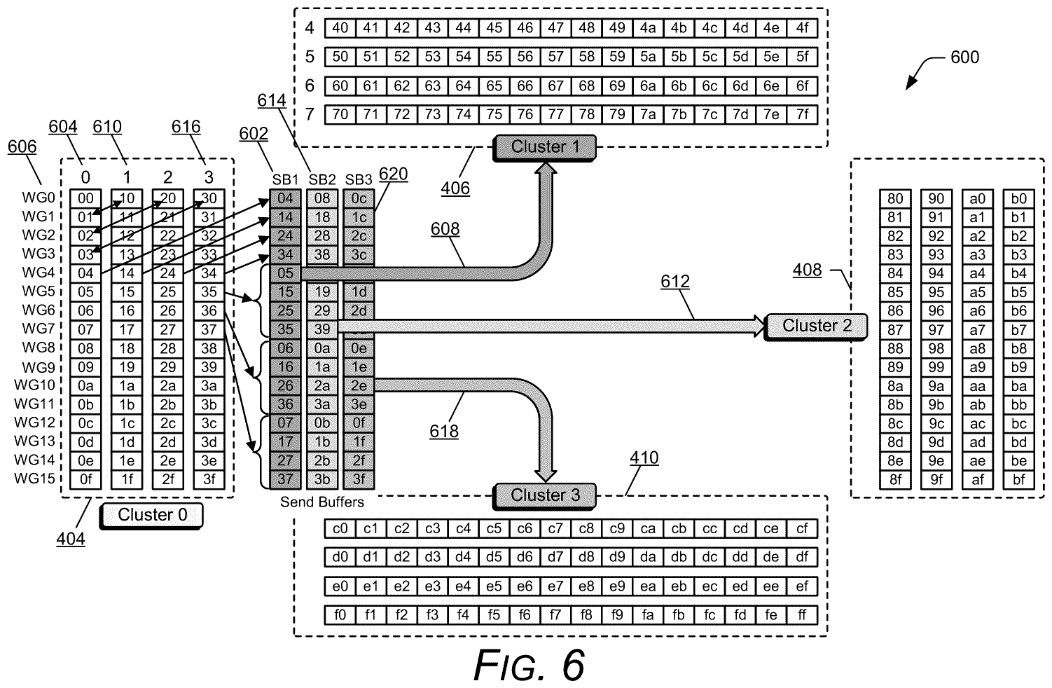

FIG. 5 further depicts a non-limiting example 500 of intra-cluster all-to-all communication in the distributed computing system 402 (FIG. 4), as related to aspects of PE-centric all-to-all communication, as described herein. In this example 500, a first stage (or first step) of the all-to-all communication procedure is intra-cluster parallel data communication between the processing elements of each of the system clusters, and the data is coalesced for inter-cluster data exchange. In an implementation, intra-cluster parallel data communication within a cluster optimizes the data for subsequent inter-cluster data exchange. For each processing element (PE_{i,c}) (e.g., GPU), a work group 502 (WGₖ) is utilized, where an individual cluster (cN<=k<c(N+1) performs intra-cluster parallel data communication between the processing elements of each of the system clusters. As shown in the example 500, each work group 502 (e.g., work groups (0-3)) in the processing element 504 (PE₀) issues a remote PUT operation to one element each to their respective destinations. The all-to-all communication patterns are archived as parallel fine-grain PUT operations performed at the work group (WG) level of granularity. Further, the data is coalesced for subsequent inter-cluster data exchange. For each processing element (PE_{i,c}) (e.g., GPU), the remaining work groups WGₖ, move data_{i,c} [k′] to Sbuf_{[k′/N]} (send buffer to cluster (k′/N)) at destination offset=N*(k′% N)+i using remote PUT.

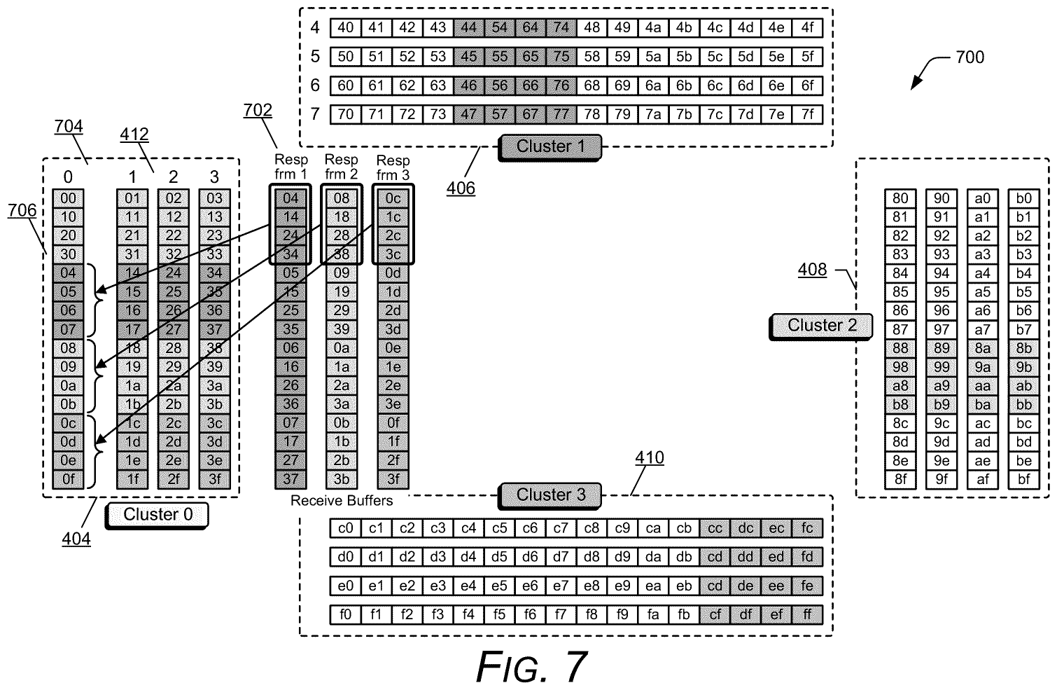

FIG. 6 further depicts a non-limiting example 600 of inter-cluster exchange for all-to-all communication in the distributed computing system 402 (FIG. 4), as related to aspects of PE-centric all-to-all communication, as described herein. In this example 600, the remainder work groups (e.g., WGs not performing the first stage or step of intra-cluster parallel data communication between the processing elements of a cluster) concurrently PUT their respective data elements to a send buffer 602 to coalesce messages to other clusters. For example, the processing element 604 (PE_{0,0}) for the work groups 606 (WG₄₋₇) copies data [04, 05, 06, 07] to the send buffer 602 (SBuf_{[1]}, e.g., the send buffer for cluster 0->1) at address offsets {0, 4, 8, 12}. The second stage (or second step) of the all-to-all communication procedure is the inter-cluster data exchange for the all-to-all data communication between the multiple clusters.

In implementations, every processing element (PE_{i,c}) (e.g., GPU) (i<C−1) moves data from a send buffer (Sbuf_{[c′i]}) to a respective cluster (c′ᵢ) receive buffer. This results in a single (e.g., only one) inter-cluster communication between every pair of clusters. This example 600 shows that for the first cluster 404 (c0), the processing element 604 (PE₀) sends coalesced data 608 as a single data message to the second cluster 406 (c1). Similarly, the processing element 610 (PE₁) sends coalesced data 612 as a single data message to the third cluster 408 (c2) from a send buffer 614, and the processing element 616 (PE₃) sends coalesced data 618 as a single data message to the fourth cluster 410 (c3) from a send buffer 620, respectively. Notably, all of the clusters in the distributed computing system are performing the described all-to-all communication procedure either synchronously or asynchronously (e.g., the same procedure as described for the first cluster 404 (c0)).

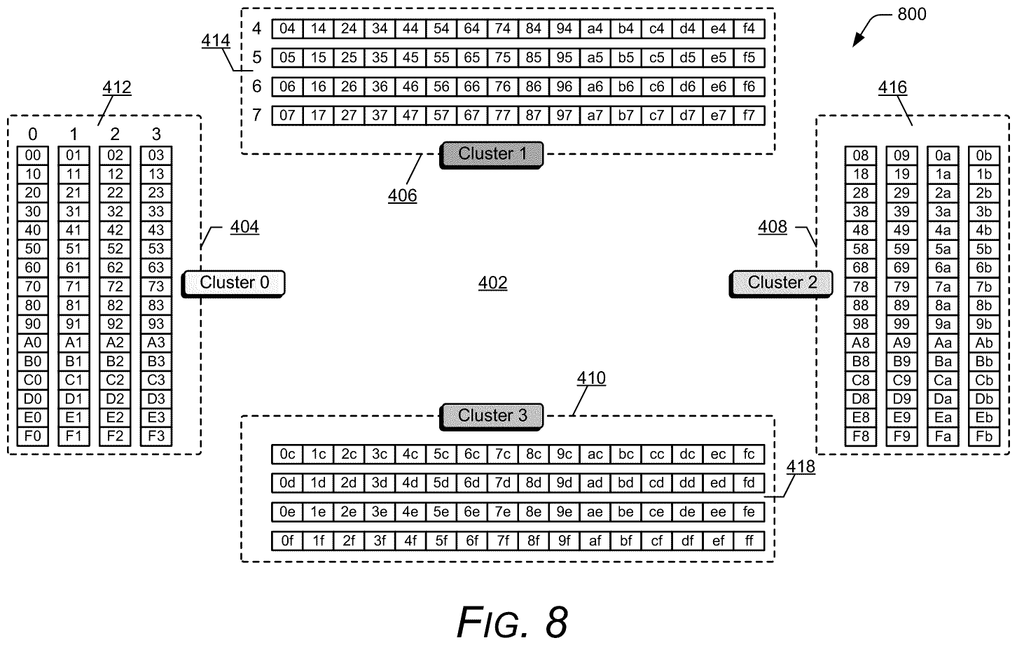

FIG. 7 further depicts a non-limiting example 700 of intra-cluster exchange for all-to-all communication in the distributed computing system 402 (FIG. 4), as related to aspects of PE-centric all-to-all communication, as described herein. In this example 700, a third stage (or third step) of the all-to-all communication procedure includes intra-cluster data distribution to the respective processing elements of each of the clusters, completing the all-to-all data communication. In implementations, for each processing element (PE_{i,c}) (e.g., GPU), a work group (WG_{d*N}) will load data from a receive buffer (Rbuf_{[d]}) (e.g., a buffer receiving data from cluster ‘d’). An offset within the receive buffer (Rbuf_{[d]})=i*N, for #elements loaded=N, into the final output buffer of processing element (PE_{i,c}) at offset d*N. This example 700 shows the receive buffers 702 for the first cluster 404 (c0). The received data is now distributed across the processing elements 412 within cluster (c0). The processing element 704 (PE_{0,0}) for work group 706 (WG₄) loads four data elements from the receive buffer (Rbuf_{[1]}) starting at offset (0*4) to the final output buffer offset (1*4).

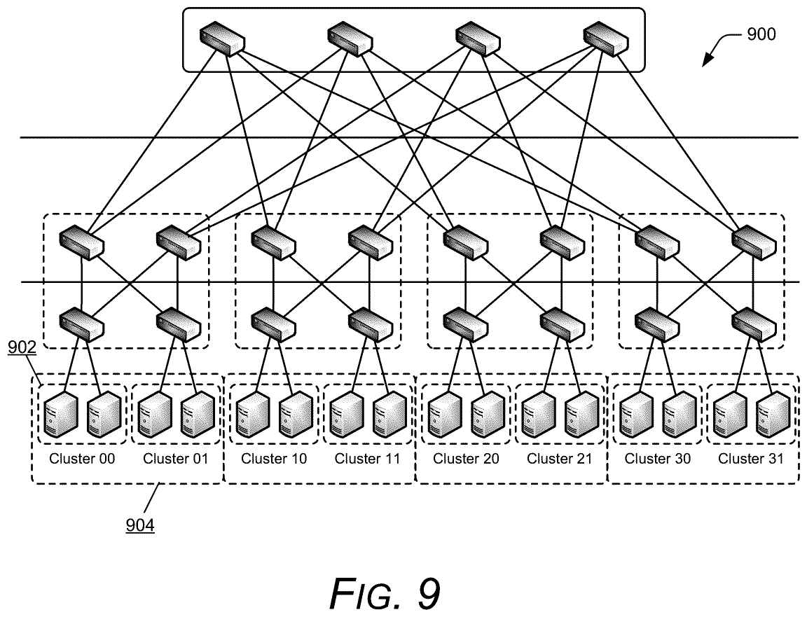

FIG. 8 further depicts a non-limiting example 800 of a final state of the distributed computing system 402 (FIG. 4), as related to aspects of PE-centric all-to-all communication, as described herein. This example 800 shows the data elements after the all-to-all data communication is completed in the distributed computing system 402. With reference to relatively small data messages, a typical all-to-all communication algorithm is restricted by packet creation latency and takes log 2(N) steps for small data messages creation. However, in aspects of the described PE-centric all-to-all communication, GPU-parallelism is utilized to parallelize packet creation, and the approach effectively performs the all-to-all communication procedure in three stages or steps, assuming or considering one level of clustering. Further, with reference to relatively large data messages, a typical all-to-all communication algorithm is restricted by network contention (e.g., bandwidth limitations). However, in aspects of the described PE-centric all-to-all communication, inter-cluster communication is optimized, needing only one message per cluster pair, thus reducing the network pressure and need for scheduling messages across the multiple processing elements, assuming that intra-cluster communication is not a bottleneck (i.e., multiple levels of cluster domains can be created to alleviate intra-cluster bottlenecks).

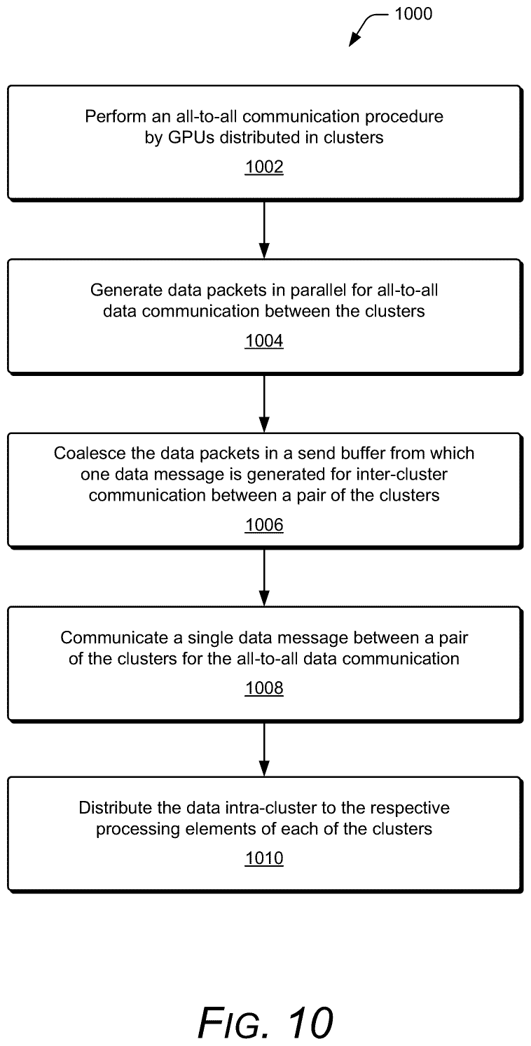

FIG. 9 depicts a non-limiting example 900 of levels of clustering, as related to aspects of PE-centric all-to-all communication, as described herein. In some instances, a single level of clustering will be insufficient to avoid intra-cluster contention or to satisfy the (N>=C) condition to perform inter-cluster communication in a single step. In this case, an additional cluster level is added, such as shown in this example 900 of a fattree topology with two levels of clustering. Notably, the approach performs the all-to-all communication procedure in only five stages or steps.

In an example implementation, a first step performs intra-cluster data exchange at a level zero 902 (i.e., within each dashed box (clusters 00, 01, 10, 11, 20, 21, 30, 31). A second step performs data exchange across clusters within level zero (i.e., data will be exchanged between cluster 00<->01, 10<->11, 20<->21, and 30<->31). In a third step, data will be communicated across second level clusters 904 (i.e., the data will be communicated across the level two clusters partitioned as indicated by the dashed boxes). In a fourth step, the data received by each of the second level clusters 904 is distributed between the level one clusters (e.g., the data received at the second level cluster is distributed between cluster 00 and 01). In a fifth step, the data received by each level one cluster is distributed across the respective processing elements of each cluster.

FIG. 10 is a flow diagram depicting a procedure 1000 in an example implementation of PE-centric all-to-all communication, as described herein. The order in which the procedure is described is not intended to be construed as a limitation, and any number or combination of the described operations are performed in any order to perform the procedure, or an alternate procedure.

In the procedure 1000, an all-to-all communication procedure is performed by GPUs distributed in clusters (at 1002). For example, the all-to-all communication procedure 310 is performed by the processing elements 304 (e.g., GPUs) in the multiple clusters 302 (e.g., clusters (0-3)) of the distributed computing system. The all-to-all communication procedure 310 includes a first stage of intra-cluster parallel data communication between respective processing elements 304 (e.g., GPUs) of each of the clusters 302, and the data is coalesced intra-cluster for an inter-cluster data exchange. The all-to-all communication procedure 310 also includes a second stage of the inter-cluster data exchange for the all-to-all data communication between the multiple clusters 302, and a third stage of intra-cluster data distribution to the respective processing elements 304 (e.g., GPUs) of each of the clusters.

Data packets are generated in parallel for all-to-all data communication between the clusters (at 1004). For example, the processing elements 304 of the respective multiple clusters 302 generate data packets in parallel for the all-to-all communication between the clusters. The data packets are coalesced in a send buffer from which a single data message is generated for inter-cluster communication between a pair of the clusters (at 1006). For example, the data packets generated by the processing elements 304 in a respective one of the clusters 302 are coalesced in a send buffer (e.g., send buffer 602) from which a single data message is generated for inter-cluster communication between a pair of the clusters.

A single data message is communicated between a pair of the clusters for the all-to-all data communication (at 1008). For example, the single data message is communicated from a send buffer of a cluster to a receive buffer of another cluster for the inter-cluster communication between the pair of clusters 302 in the distributed computing system. The data is distributed intra-cluster to the respective processing elements of each of the clusters (at 1010). For example, from the data messages communicated inter-cluster, an intra-cluster data distribution is performed to distribute the data to the respective processing elements 304 of each of the multiple clusters 302.

The various functional units illustrated in the figures and/or described herein (including, where appropriate, a processing element or GPU) are implemented in any of a variety of different forms, such as in hardware circuitry, software, and/or firmware executing on a programmable processor, or any combination thereof. The procedures provided are implementable in any of a variety of devices, such as a general-purpose computer, a processor, a processor core, and/or an in-memory processor. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Although implementations of PE-centric all-to-all communication have been described in language specific to features, elements, and/or procedures, the appended claims are not necessarily limited to the specific features, elements, or procedures described. Rather, the specific features, elements, and/or procedures are disclosed as example implementations of PE-centric all-to-all communication, and other equivalent features, elements, and procedures are intended to be within the scope of the appended claims. Further, various different examples are described herein and it is to be appreciated that many variations are possible and each described example is implementable independently or in connection with one or more other described examples.

What is claimed is:

1. A distributed computing system, comprising:
multiple clusters that each include processing elements; and
an all-to-all communication procedure performed by the processing elements that are each configured to generate data packets in parallel for all-to-all data communication between the multiple clusters.

2. The distributed computing system of claim 1, wherein the processing elements of the multiple clusters are graphics processing units (GPUs).

3. The distributed computing system of claim 1, wherein the processing elements are each configured to communicate the data packets in parallel intra-cluster.

4. The distributed computing system of claim 3, wherein the data packets include at least GET requests or PUT requests communicated by the processing elements in parallel intra-cluster.

5. The distributed computing system of claim 1, wherein a single data message is communicated between a pair of the multiple clusters for the all-to-all data communication between the multiple clusters.

6. The distributed computing system of claim 5, wherein the data packets are coalesced in a send buffer from which the single data message is generated for inter-cluster communication between the pair of the multiple clusters.

7. The distributed computing system of claim 6, wherein the single data message is communicated from the send buffer to a receive buffer for the inter-cluster communication between the pair of the multiple clusters.

8. The distributed computing system of claim 1, wherein the all-to-all communication procedure comprises:
a first stage of intra-cluster parallel data communication between respective processing elements of each of the multiple clusters, and data is coalesced for inter-cluster data exchange;
a second stage of the inter-cluster data exchange for the all-to-all data communication between the multiple clusters; and
a third stage of intra-cluster data distribution to the respective processing elements of each of the multiple clusters.

9. The distributed computing system of claim 1, wherein the all-to-all communication procedure is performed in a number of steps that is twice a number of clustering levels plus one additional step.

10. An all-to-all communication procedure executable by graphics processing units (GPUs) distributed in clusters, the all-to-all communication procedure comprising:
a first stage of intra-cluster parallel data communication between respective GPUs of each of the clusters;
a second stage of inter-cluster data exchange for all-to-all data communication between the clusters; and
a third stage of intra-cluster data distribution to the respective GPUs of each of the clusters.

11. The all-to-all communication procedure of claim 10, wherein the first stage includes data coalesced intra-cluster for the inter-cluster data exchange.

12. The all-to-all communication procedure of claim 11, wherein data is coalesced in a send buffer from which a single data message is generated for the inter-cluster data exchange between a pair of the clusters.

13. The all-to-all communication procedure of claim 10, wherein the second stage comprises a single data message being communicated between a pair of the clusters for the inter-cluster data exchange.

14. The all-to-all communication procedure of claim 13, wherein the single data message is communicated from a send buffer to a receive buffer for the inter-cluster data exchange between the pair of the clusters.

15. A method, comprising:
performing an all-to-all communication procedure by GPUs distributed in clusters;
generating data packets in parallel for all-to-all data communication between the clusters; and
communicating a single data message between a pair of the clusters for the all-to-all data communication.

16. The method of claim 15, further comprising:
coalescing the data packets in a send buffer from which the single data message is generated for inter-cluster communication between the pair of the clusters.

17. The method of claim 16, further comprising:
communicating the single data message from the send buffer to a receive buffer for the inter-cluster communication between the pair of the clusters.

18. The method of claim 15, wherein the all-to-all communication procedure comprises a first stage of intra-cluster parallel data communication between respective GPUs of each of the clusters.

19. The method of claim 18, wherein the all-to-all communication procedure comprises a second stage of an inter-cluster data exchange for the all-to-all data communication between the clusters.

20. The method of claim 19, wherein the all-to-all communication procedure comprises a third stage of intra-cluster data distribution to the respective GPUs of each of the clusters.
